(19) United States
(12) Patent Application Publication
(10) Pub. No.: US 2018/0123779 A1
(43) Pub. Date: May 3, 2018

(54) Flexible Blockchain Smart-Contract Deployment

(71) Applicant: Jiangang Zhang, San Jose, CA (US)

(72) Inventor: Jiangang Zhang, San Jose, CA (US)

(21) Appl. No.: 15/669,515

(22) Filed: Aug. 4, 2017

Related U.S. Application Data
(60) Provisional application No. 62/415,509, filed on Nov. 1, 2016.

(51) Int. Cl. H04L 9/06; H04L 9/32

(52) U.S. Cl. CPC H04L 9/0637; H04L 9/3247; G06Q 20/065; G06Q 2220/00; H04L 2209/56

(57) ABSTRACT

A flexible blockchain smart-contract deployment design supporting both selective on-chain deployment and remote deployment with verified determinism and other valuable blockchain properties.

### CROSS REFERENCE TO RELATED APPLICATION

This application claims priority from U.S. Patent Application No. 62/415,509, filed Nov. 1, 2016 and entitled “Flexible blockchain smart-contract deployment” the disclosure of which is hereby incorporated entirely herein by reference.

### FIELD OF THE INVENTION

The present invention is in the technical field of blockchain smart-contract deployment. More particularly, the present invention is in the technical field of achieving privacy, security and scalability in blockchain smart-contract deployment and execution.

### BACKGROUND OF THE INVENTION

Conventional blockchains, e.g. bitcoin, Ethereum, HyperLedger etc., all require a smart-contract to be deployed on-chain on every blockchain validating node, which is not only unnecessary, but also leads to scalability concern on blockchain nodes, as well as privacy and security concerns on implementing smart-contracts on public or consortium blockchains.

### SUMMARY OF THE INVENTION

The present invention leverages two facts about smart-contracts on the blockchain that make it possible for flexible deployment of blockchain smart-contracts without compromising the trustworthy and verified determinism property of the blockchain smart-contracts.

The first fact is that, a smart-contract must be deterministic, i.e. all runtime instances of a smart-contract on a blockchain must start with the same initial state and, given the same input, it must arrive to the same state; there's no restriction needed to host all (or any) instances of a smart-contract on each blockchain node at all.

The second fact is that, the runtime redundancy and availability protection of a smart-contract does not necessarily mean it must run on every blockchain validating node; instead, it can be defined, globally across a blockchain or on per smart-contract basis, in terms of redundancy factor, denoted rf here in the present invention.

The present invention, make is possible for a smart-contract deployment operator, to specify the deployment criteria (e.g. on-chain on each node, on-chain on some nodes, or totally remotely, or some remote some on-chain etc). Also, a blockchain validating node can specify its execution criteria on smart-contracts (hosted locally or remotely).

On receiving a smart-contract deployment request, each blockchain validating node matches its execution criteria against the deployment criteria of the smart contract, to decide whether to host it locally, or execute it remotely on receiving transactions destined toward it.

Blockchain validating nodes, periodically multi-cast, to every other node in the blockchain, a message, denoted SC_LIST, which includes signed information on current smart-contracts that it's responsible to execute locally or remotely under its execution criteria.

Blockchain validating nodes that are responsible for executing a smart-contract forms an ordered list based on certain criteria, denoted as smart-contract cluster in the present invention; with the first being the master, then 1st slave, 2nd slave, and so on. Any master election criteria can apply if so desired. On change of master, role change applies accordingly.

On receiving the SC_LIST message, each blockchain validating node, stores the information received locally, and calculate its standing in the smart-contract cluster for each smart-contract it is responsible for executing locally or remotely. This calculation is also triggered periodically to account for the potential unreachability of a blockchain validating node.

When the blockchain receives a transaction, X, destined to a smart-contract, each validating node decides if it is responsible for executing the transaction targeted to the smart-contract. If the target smart-contract falls within its execution criteria, it would execute it locally or remotely and have the state update proposal (as result of execution of transaction X) message, denoted TX_STATE, multi-cast to all other blockchain validating nodes.

All members in the smart-contract cluster, collects the TX_STATE messages. The master in the cluster, wait until either a consensus decision on the new state can be made, or time out, then multicasts a self-signed state update transaction Y (related to transaction X) to all blockchain validating nodes. The state update transaction Y includes the cryptographical hash of transaction X, the state details, information of the initiating validating node etc.

Upon receiving transaction Y, if it's a valid consensus on state as result of transaction X, each blockchain validating node accepts execution of transaction X and applies the (new) state (if applicable) to make both transaction X and Y ready to be enclosed into a blockchain block (“blockchain mining”). If it's non-consensus either explicitly or implicitly due to timeout, execution of transaction X is accepted with no state change with transaction Y accepted with details of the explicit or implicit non-consensus.

Note that if a smart-contract is meant to be deployed on every validating node of a blockchain as specified in its deployment criteria, normal blockchain transaction execution strategy applies and hence not elaborated in the present invention.

Deploying the smart contract remotely, combined with out-of-band secure data transmission with blockchain immutability protection on data transmitted, fully secure and private smart-contracts can be realized on public or consortium blockchains.

### BRIEF DESCRIPTION OF THE DRAWING

FIG. 1 is the sequence diagram on deploying a smart-contract to a blockchain. Here block 100 represents a smart-contract deployment operator, block 101 (including 101.A, 101.B and 101.C) represents all nodes in a three-node blockchain. Here two blockchain nodes (101.A and 101.B) decides to execute transactions destined to the smart-contract by deploying and executing it locally or forwarding it for remote execution.

FIG. 2 is the sequence diagram on periodic multicast of information on smart-contracts that each blockchain node is responsible for execution (locally or remotely), as well as periodic calculation/update of mastership for each smart-contract cluster based on pre-defined rules. Here block 201.A, 201.B and 201.C respectively represents a node in a three-node blockchain with 201.A chosen to initiate the multicast to illustrate the flow.

FIG. 3 is the sequence diagram on transaction execution by all instances of a smart-contract orchestrated by the blockchain. Block 301 represents the transaction initiator, block 302.A, 302.B and 302.C respectively represents a node in a three-node blockchain

### DETAILED DESCRIPTION OF THE INVENTION

The Problem Statement

Conventional blockchains, e.g. bitcoin, Ethereum, HyperLedger etc., all require a smart-contract to be deployed on-chain on every blockchain validating node, which is not only unnecessary, but also leads to potentially serious concerns and issues en route blockchain adoption in real-world use cases.

First, is the potential scalability concern on all blockchain validating nodes. A blockchain could have many smart-contracts deployed and each consumes and competes against other smart-contracts on CPU power, memory, storage, network bandwidth etc. on each validating nodes (computers).

Second, is the potential security and privacy concern on deploying a private smart-contract on a public or consortium blockchain. The reason being, a smart-contract is codification of a business logic, which is realization of potentially secret business contracts, and a private smart-contract processes potential sensitive and confidential business and personal data. Having smart-contracts on each blockchain validating node makes it difficult if not impossible to implement fully private smart-contracts on public or consortium blockchains.

Flexible Smart Contract Deployment

The blockchain enables automated execution with verified determinism of smart-contract execution, the prerequisite of which to a smart-contract is its determinism by design, not where it is deployed and how many instances of a smart contract is deployed, because the latter is just a normal redundancy and availability concern instead of a blockchain or smart-contract specific concern.

So long as a smart-contract is deterministic, it can be deployed selective on-chain, off-chain remotely, or hybrid deployment. Here “selective on-chain” means all instances of a smart-contract are deployed on all or some blockchain validating nodes, “off-chain remotely” means all instances of a smart-contract are deployed outside of the blockchain (i.e. not on any blockchain validating nodes), “hybrid deployment” means that some instances of a smart-contract are deployed on some validating nodes of the blockchain (selective on-chain) while other instances of the same smart-contract are deployed off-chain remotely outside of the blockchain.

Regardless of the location of instances of a smart-contract, so long as they are only deterministically executed with the same ordered set of transactions from the blockchain (input) and has their state (outcome) deterministically consented and verified by the blockchain, the trustworthy execution of business contracts as codified by the smart-contracts holds.

Runtime redundancy and availability of a smart-contract can be achieved via multiple simultaneously running instances that are deployed on-chain selectively, off-chain remotely, or a combination of both. This does not exclude the traditional one-instance-per-blockchain-validating-node approach, however.

The present invention leverages these facts to enable flexible smart-contract deployment to solve the potential scalability issue on blockchain validating nodes, as well as potential security and privacy issues on deploying fully private smart-contracts on public or consortium blockchains.

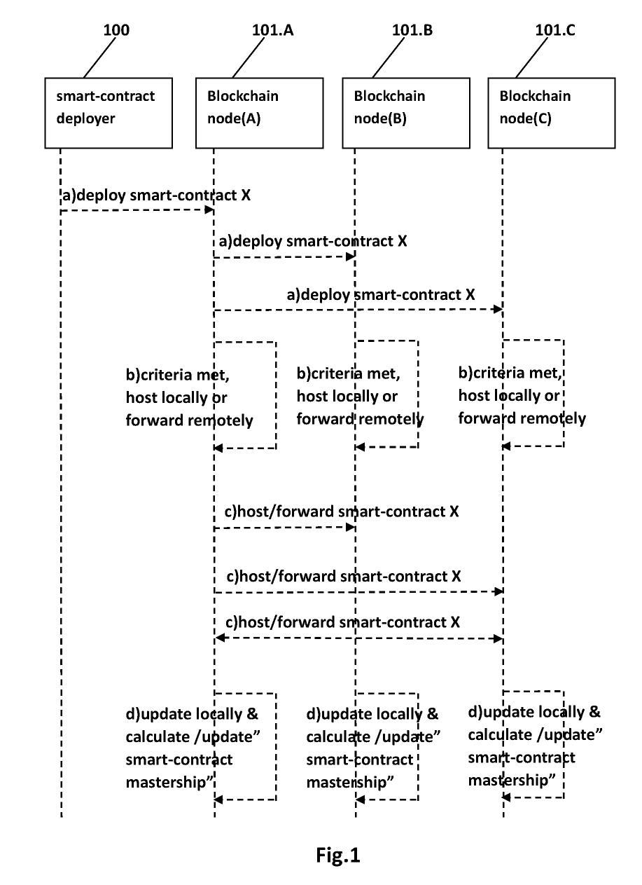

On deploying a smart-contract, as shown in FIG. 1, in step a) a smart-contract deployment operator initiates a self-signed deployment transaction to deploy smart-contract X. This transaction is multicast directly (or via a “proxy”) to all blockchain validating nodes. Included in the deployment transaction are, among other info, type of deployment (on-chain on every node, selective on-chain, off-chain remotely or hybrid), number of instances, deployment criteria on selecting the right blockchain validating nodes (if on-chain), etc.

Update receiving the deployment transaction, in step b), each blockchain validating node matches the deployment criteria against its own execution criteria (what or what kind of smart-contracts it's taking responsibility to host locally or execute remotely). If mismatch, as is the case for blockchain validating node 101.C in FIG. 1, the blockchain validating node just ignores the transaction silently. If criteria met, as with blockchain validating nodes denoted by 101.A and 101B, the blockchain node will multicast to all blockchain nodes, in step c), a self-signed SC_LIST message with all smart-contracts including the new one. The SC_LIST message is a list of smart-contracts that the sending node is responsible for execution (locally or remotely) together with the original deployment transaction of each smart-contract enclosed.

On receiving a SC_LIST message, in step d), after verifying its legitimacy, each blockchain validating node will update (or create if nonexistent) the “smart-contract cluster” (one per smart-contract) for each node responsible for the execution of a smart-contract. A smart-contract cluster, is composed of an ordered set of blockchain validating nodes responsible for the execution (locally or remotely) of a specific smart-contract; the exact number of nodes equals to the redundancy factor for the smart-contract, denoted rf in the present invention. Any fair and robust master-election mechanism can apply on the smart-contract cluster and any master rotation mechanism can apply as well.

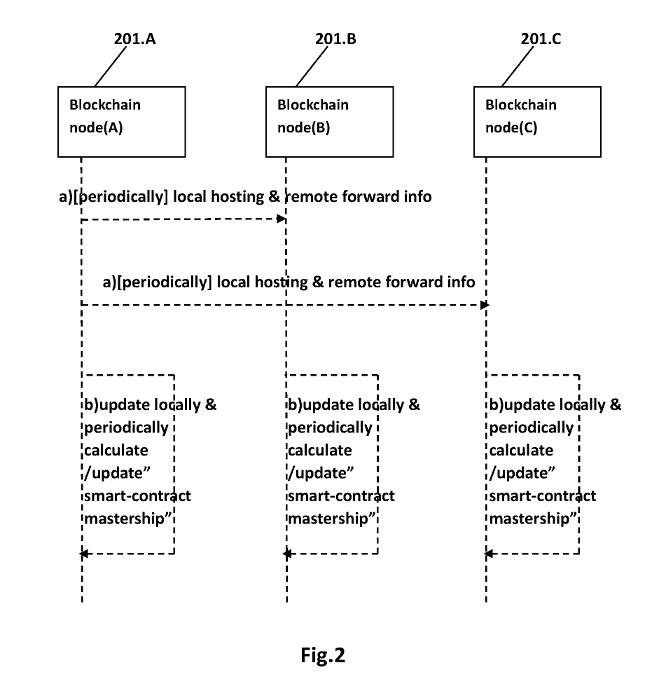

As shown in FIG. 2, each blockchain validating node periodically multicasts, in step a) SC_LIST to all other blockchain validating nodes, so that each node gets to know and apply, in step b), the updated whole picture on which node is responsible for execution of which smart-contract(s).

Step b) in FIG. 2 is the same as step d) in FIG. 1, it's trigged either on receiving a SC_LIST message or periodically so that inactive nodes in a smart-contract cluster can be removed. On removing an inactive blockchain validating node from a smart-contract, if the total active number of execution nodes is below the redundancy factor, rf, an alarm can be set to trigger manual or automated re-deployment.

Smart Contract Invocation

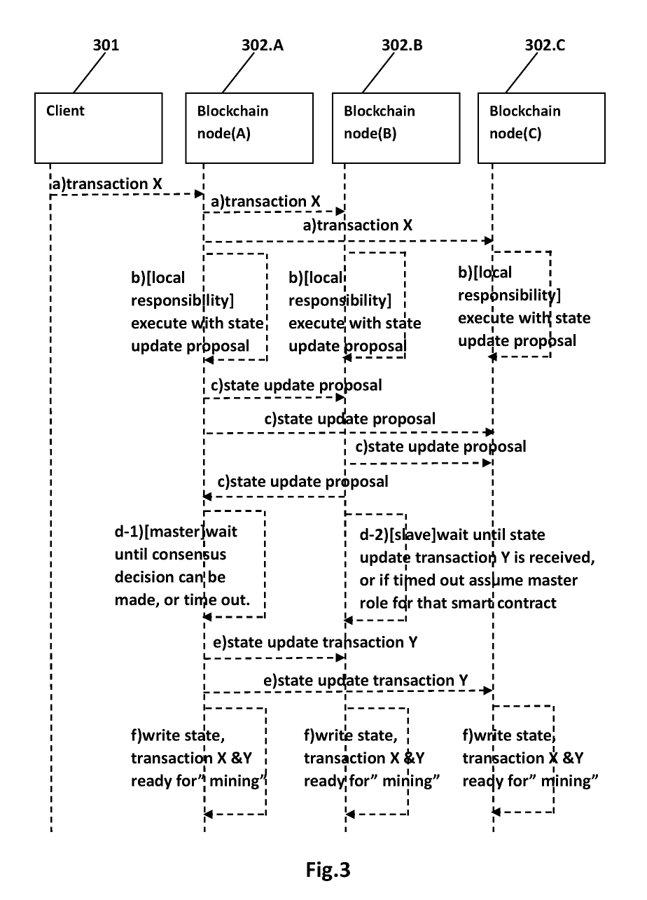

As shown in FIG. 3, when a client, represented by block 301, initiates a transaction X targeting a smart contract, as in step a), this transaction X is multicast to all blockchain validating nodes for execution. The transaction will be locked to be prevented from enclosed in a blockchain block.

In step b) as in FIG. 3, each blockchain validating node checks whether it's responsible for the execution of the target smart-contract. If no as on blockchain node represented by block 302.C, the execution is silently ignored. If yes as on blockchain nodes represented by block 302.A and 302.B, it would execute the smart-contract (locally or remotely) and multicasts the signed state update proposal message, ST_UPDATE to all other blockchain validating nodes as in step c). The ST_UPDATE message includes, among other info, the cryptographic hash of corresponding transaction X, the ID of the node executing the transaction, the state proposal, timestamp, etc.

As shown in step d-1) in FIG. 3, the “master” of the smart-contract cluster for the specific smart-contract, waits until consensus can be reached on execution of transaction X, or time out before a consensus can be reached, then it sends a self-signed state update transaction Y to all blockchain validating nodes in step e). The state update transaction Y, includes the cryptographical hash of transaction X, consent state (or not if timeout or failed to consent), etc.

Worth mentioning is step d-2), each slave node in the smart-contract cluster, wait until the aforementioned state update transaction Y is received, or time out to assume master role for that smart contract executing transaction X. The timeout value depends on the node's distance from the current master in the ordered list of the smart-contract cluster.

On receiving state update transaction Y, each blockchain validating node updates the blockchain state, unlocks transaction X and Y to be ready for “mining” (i.e. to be ready to be enclosed in a block). From here on, normal blockchain processing logic applies.

Note that if a smart-contract is deployed on all blockchain validating nodes, “normal” execution logic applies on handling its transactions. In that case, in step b) of FIG. 3 each node executes transaction X on the smart contract and writes the state (outcome) to the blockchain and from here on, normal blockchain processing logic applies.

The invention claimed:

1. A flexible blockchain smart-contract deployment is about smart-contracts on the blockchain that make flexible deployment of blockchain smart-contracts without compromising the trustworthy and verified determinism property of the blockchain smart-contracts;
wherein a smart-contract deployment operator specifies the deployment criteria, as well as a blockchain validating node specifies its execution criteria on smart-contracts hosted locally or remotely;
wherein on receiving a smart-contract deployment request, each blockchain validating node matches its execution criteria against the deployment criteria of the smart contract, to decide whether to host it locally, or execute it remotely on receiving transactions destined toward it;
wherein blockchain validating nodes, periodically multi-cast, to every other node in the blockchain, a message, which includes signed information on current smart-contracts that it's responsible to execute locally or remotely under its execution criteria.

2. A flexible blockchain smart-contract deployment according to claim 1, wherein blockchain validating nodes that are responsible for executing a smart-contract forms an ordered list based on certain criteria with the first being the master, then 1st slave, 2nd slave, and so on. Any master election criteria can apply if so desired. On change of master, role change applies accordingly.

3. A flexible blockchain smart-contract deployment according to claim 1, wherein on receiving the SC_LIST message, each blockchain validating node, stores the information received locally and calculates its standing in the smart-contract cluster for each smart-contract it is responsible for executing locally or remotely. This calculation is also triggered periodically to account for the potential unreachability of a blockchain validating node.

4. A flexible blockchain smart-contract deployment according to claim 1, wherein when the blockchain receives a transaction, X, destined to a smart-contract, each validating node decides if it is responsible for executing the transaction targeted to the smart-contract. When the target smart-contract falls within its execution criteria, it would execute it locally or remotely and have the state update proposal (as result of execution of transaction X) message, multi-cast to all other blockchain validating nodes.

5. A flexible blockchain smart-contract deployment according to claim 1, wherein all members in the smart-contract cluster, collects the TX_STATE messages. The master in the cluster, wait until either a consensus decision on the new state can be made, or time out, then multicasts a self-signed state update transaction Y (related to transaction X) to all blockchain validating nodes. The state update transaction Y includes the cryptographical hash of transaction X, the state details, information of the initiating validating node etc.

6. A flexible blockchain smart-contract deployment according to claim 1, wherein upon receiving transaction Y, when it's a valid consensus on state as result of transaction X, each blockchain validating node accepts execution of transaction X and applies the (new) state to make both transaction X and Y ready to be enclosed into a blockchain block (“blockchain mining”);
wherein when it's non-consensus either explicitly or implicitly due to timeout, execution of transaction X is accepted with no state change with transaction Y accepted with details of the explicit or implicit non-consensus.

7. A flexible blockchain smart-contract deployment according to claim 1, wherein deploying the smart contract remotely, combined with out-of-band secure data transmission with blockchain immutability protection on data transmitted, fully secure and private smart-contracts can be realized on public or consortium blockchains.
